(19) United States
(12) Patent Application Publication
(10) Pub. No.: US 2013/0339638 A1
(43) Pub. Date: Dec. 19, 2013

(54) STATUS POLLING OF MEMORY DEVICES USING AN INDEPENDENT STATUS BUS

(71) Applicants: Tal Lazmi, Herzliya (IL); Asaf Schushan, Ramat Hasharon (IL); Asaf Bart, Petach Tikva (IL)

(72) Inventors: Tal Lazmi, Herzliya (IL); Asaf Schushan, Ramat Hasharon (IL); Asaf Bart, Petach Tikva (IL)

(21) Appl. No.: 13/589,592

(22) Filed: Aug. 20, 2012

Related U.S. Application Data
(60) Provisional application No. 61/661,505, filed on Jun. 19, 2012.

(51) Int. Cl. G06F 12/00

(52) U.S. Cl. 711/156; 711/E12.001

(57) ABSTRACT

Apparatus includes multiple memory devices and a memory controller. The memory controller is configured to store and retrieve data by communicating with the memory devices over a first bus interface, and to query a status of the memory devices by communicating with the memory devices over a second bus interface that is separate from the first bus interface.

### CROSS-REFERENCE TO RELATED APPLICATIONS

This application claims the benefit of U.S. Provisional Patent Application 61/661,505, filed Jun. 19, 2012, whose disclosure is incorporated herein by reference.

### FIELD OF THE INVENTION

The present invention relates generally to data storage, and particularly to methods and systems for memory device interfaces.

### BACKGROUND OF THE INVENTION

In many memory systems, memory devices report their activity status, i.e., whether they are busy or ready to receive new commands. For example, some Flash memory devices comprise a Ready/Busy (R/B or RnB) line for reporting their activity status to a memory controller.

Various techniques and interfaces for querying and reporting the status of memory devices are known in the art. For example, U.S. Patent Application Publication 2009/0089492, whose disclosure is incorporated herein by reference, describes a polling process among one or more Flash memory devices. In some implementations, the polling process includes sending a read status command to a Flash memory device to detect the ready or busy state of the Flash memory device. A status register is included in the Flash memory device for storing a status signal indicating an execution state of a write (or erase) operation. A solid state drive system may perform the polling process by reading the status register of the flash memory device.

As another example, U.S. Patent Application Publication 2004/0049628, whose disclosure is incorporated herein by reference, describes a non-volatile memory subsystem that comprises a plurality of non-volatile memory integrated circuit chips. Each of the plurality of integrated circuit memory chips is capable of being read, erased or programmed. Each of the plurality of memory chips further has a data bus and an address bus. A controller chip is coupled to the plurality of memory chips and receives a plurality of externally supplied tasks to be executed by the plurality of memory chips. The controller chip further comprises a task scheduler for scheduling the simultaneous execution of the plurality of tasks by the plurality of memory chips and a status poll scheduler for polling each of the plurality of memory chips to determine when a memory chip has completed its task.

### SUMMARY OF THE INVENTION

An embodiment of the present invention that is described herein provides an apparatus including multiple memory devices and a memory controller. The memory controller is configured to store and retrieve data by communicating with the memory devices over a first bus interface, and to query a status of the memory devices by communicating with the memory devices over a second bus interface that is separate from the first bus interface.

In some embodiments, the memory devices and the memory controller are connected in a serial cascade using the second bus interface, and each memory device is configured to receive a partial status word from a preceding element in the cascade, to add a respective status report of the memory device to the partial status word and to send the partial status word having the added status report to a next element in the cascade. In an embodiment, the memory controller is configured to receive a full status word from a last memory device in the cascade, and to extract respective status reports of the multiple memory devices from the full status word.

In other embodiments, the memory controller is configured to send to each memory device over the second bus interface a respective status request indicating a respective address of the memory device, and each memory device is configured to respond to the status request by sending a respective status report over the second bus interface. In an embodiment, the memory controller is configured to send the status request in a first cycle of the second bus interface, and to receive the respective status report in one or more second cycles of the second bus interface that are subsequent to the first cycle.

In a disclosed embodiment, the second bus interface is serial. In another embodiment, the second bus interface is parallel. In an example embodiment, the memory controller is configured to query the status of the memory devices using the second bus interface concurrently with conducting a current storage transaction in the memory devices using the first bus interface. The memory controller may be configured to specify a subsequent storage transaction based on the queried status, and/or to initiate a subsequent storage transaction based on the queried status immediately following an end of the current storage transaction.

In some embodiments, the status includes, for each memory device, a respective indication that indicates whether the memory device is busy or ready to receive a subsequent command on the first bus interface.

There is additionally provided, in accordance with an embodiment of the present invention, a method using a memory controller. The method includes storing data in multiple memory devices by communicating with the memory devices over a first bus interface. A status of the memory devices is queried using the memory controller by communicating with the memory devices over a second bus interface that is separate from the first bus interface.

There is also provided, in accordance with an embodiment of the present invention, an apparatus including an interface and circuitry. The interface is configured for communicating with multiple memory devices. The circuitry is configured to store data in the memory devices by communicating with the memory devices over a first bus, and to query a status of the memory devices by communicating with the memory devices over a second bus that is separate from the first bus.

There is also provided, in accordance with an embodiment of the present invention, an apparatus including a memory and circuitry. The circuitry is configured to exchange data between the memory and a memory controller by communicating with the memory controller over a first bus, and to provide a status of the apparatus by communicating with the memory controller over a second bus that is separate from the first bus.

The present invention will be more fully understood from the following detailed description of the embodiments thereof, taken together with the drawings in which:

### BRIEF DESCRIPTION OF THE DRAWINGS

FIGS. 1 and 2 are block diagrams that schematically illustrate memory systems, in accordance with embodiments of the present invention.

### DETAILED DESCRIPTION OF EMBODIMENTS

### Overview

Embodiments of the present invention that are described herein provide improved methods and systems for reporting the status of memory devices in data storage systems. In the disclosed embodiments, a memory system comprises a memory controller that controls multiple memory devices such as Flash devices. The memory devices may comprise, for example, memory dies or packaged devices.

The memory controller stores data in the memory devices using a first bus interface, referred to as an Input/Output (I/O) bus. Status reporting, on the other hand, is carried out over a second bus interface, referred to as a status bus, which is separate from the I/O bus.

In the context of the present patent application and in the claims, the term “status” refers to any information that is indicative of the present operating conditions of a memory device. The embodiments described herein refer mainly to Ready/Busy (R/B) status, i.e., an indication of whether the memory device is currently ready to receive new commands on the I/O bus or whether it is currently busy executing a command. The disclosed techniques, however, are not limited to R/B status and can be used for various other status types. Examples of other status types comprise, but are not limited to, operation pass or fail and/or write protect. As yet another example, when operating in cache mode, the memory device may provide R/B status for individual circuitry, e.g., R/B for the non-volatile memory array and/or for the internal volatile buffer of the memory device.

In some disclosed embodiments, the status bus is serial. In an example embodiment, the memory devices are connected using the status bus in a serial cascade, one after the other. The first and last memory devices in the cascade are connected to the memory controller, so as to form a communication ring.

Each memory device is configured to receive a serial status word over the status bus from the preceding element in the cascade (the preceding memory device, or the memory controller in the case of the first memory device in the cascade). Each memory device adds its respective status report to the serial status word, and forwards the updated status word over the status bus to the next element in the cascade (the next memory device, or the memory controller in the case of the last memory device in the cascade).

The memory controller queries the status of the multiple memory devices by serially clocking the status word to the first memory device in the cascade, and onwards from one memory device to the next along the status bus. After a predefined number of bus cycles, the memory controller receives from the last memory device in the cascade a full status word whose bits comprise the status reports of the multiple memory devices.

In other disclosed embodiments, the status bus is parallel. Each memory device is assigned a unique address for the purpose of status querying. The memory controller queries the status of a given memory device by sending on the status bus a status request indicating the address of the given memory device. In the next bus cycle, the given memory device responds by sending its status report on the status bus.

By separating the status bus from the I/O bus used for data storage, the memory controller is able to achieve small storage latency and high I/O bus utilization. For example, when a current storage transaction is in progress (on the I/O bus), the memory controller may query the status of the memory devices (using the separate status bus), such that the up-to-date status is already available when the current storage transaction ends. Thus, the memory controller is able to plan the next storage transaction based on the up-to-date memory device status, and start the next storage transaction immediately after the end of the current transaction.

### Status Polling Using Independent Serial Status Bus

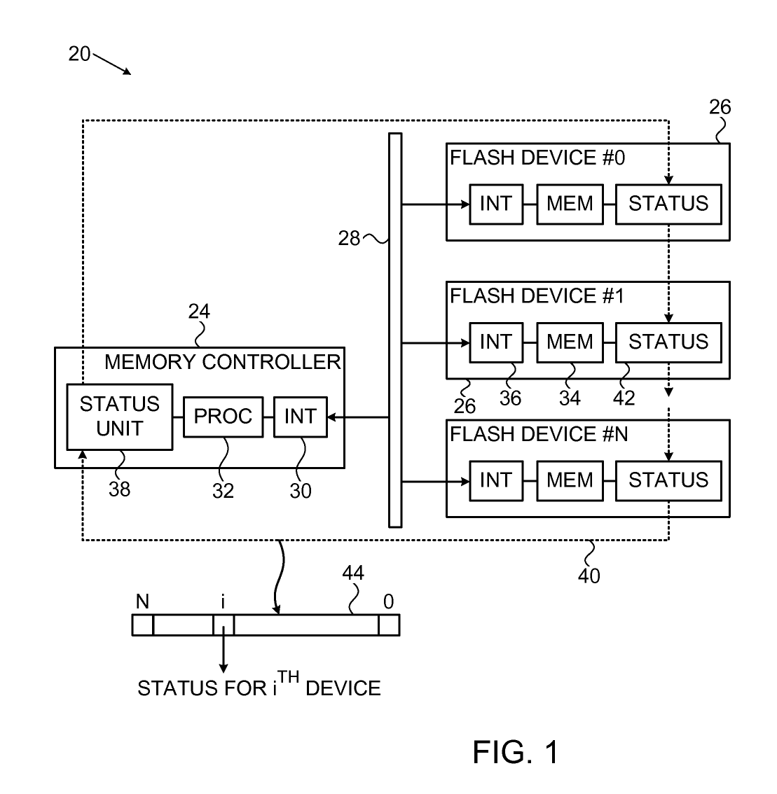

FIG. 1 is a block diagram that schematically illustrates a memory system 20, in accordance with an embodiment of the present invention. System 20 comprises a memory controller 24, which stores data in multiple Flash memory devices 26 using an Input/Output (I/O) bus 28. Each Flash memory device 26 may comprise a semiconductor die or a packaged device.

In the present example, system 20 comprises a Solid State Drive (SSD) that comprises a total of N+1 memory devices 26 denoted #0 . . . #N. In alternative embodiments, however, system 20 may comprise any other suitable memory system that comprises multiple memory devices of any suitable kind.

Memory controller 24 comprises an interface 30 for communicating with memory devices 26 over I/O bus 28, and a processor 32 that carries out the disclosed techniques. In addition, the memory controller comprises a status unit 38, which queries the status (e.g., Ready/Busy activity status) of memory devices 26 using a status bus 40 that is separate from I/O bus 28.

Each memory device 26 comprises a memory 34, e.g., one or more arrays of Flash memory cells, an interface 36 for communicating with memory controller 24 over I/O bus 28 for the purposes of data storage, and a status unit 42 for communicating over status bus 40 for the purposes of status reporting. (As explained above, status unit 42 may be used for reporting various types of status of any desired complexity, not necessarily a single R/B bit value. In the description that follows, status units 42 are referred to as R/B units for clarity.)

In the example of FIG. 1, status bus 40 is serial. R/B units 42 of memory devices 26 are connected to one another in a serial cascade using status bus 40. The R/B units of the first and last memory devices in the cascade (devices 0 and N) are connected to status unit 38 of memory controller 24.

The R/B unit of each memory device is configured to receive a serial status word over status bus 40 from the preceding element in the cascade (the preceding memory device, or the memory controller in the case of memory device #0). The R/B unit in a given memory device adds (e.g., appends) its respective status report (e.g., R/B bit) to the serial status word, and forwards the updated status word over status bus 40 to the next element in the cascade (the next memory device, or the memory controller in the case of memory device #N).

Typically, each memory device 26 comprises a status input interface for receiving the serial status word over status bus 40 from the preceding element in the cascade, and a status output interface for forwarding the updated status word over status bus 40 to the next element in the cascade.

Status unit 38 in memory controller 24 queries the status of the multiple memory devices by serially clocking some initial status word to memory device #0. The actual bit values in the initial status word are arbitrary, since they are later overwritten by memory device status reports. The status word is clocked serially along status bus 40 from one memory device to the next. As explained above, each memory device adds its R/B bit value to the serial data word.

After a predefined number of bus cycles, the memory controller receives from memory device #N a full status word having N+1 bits. The N+1 bits of the full status word comprise the status reports of the multiple memory devices. In other words, the i^{th} bit in the status word provided by memory device #N comprises the R/B status bit value of the i^{th} memory device. In one embodiment, the memory controller comprises a shift register 44 that holds the full serial status word at the end of the process.

In alternative embodiments, each R/B unit 42 may add more than a single status bit. Moreover, different memory devices 26 may add different numbers of status bits. This feature enables the memory devices to report more complex or detailed status reports. In some embodiments, memory controller 24 may support two or more status buses 40, each status bus connecting a respective subset of memory devices 26. This sort of configuration may be preferable when the number of memory devices is large.

The connectivity of FIG. 1 may be applied between different memory devices, and/or between different memory units or memory arrays within a given memory device. For example, when a given memory device comprises multiple arrays of memory cells, which may differ from one another in ready/busy status, the scheme of FIG. 1 may be applied to individual arrays within the memory device.

### Status Polling Using Independent Parallel Status Bus

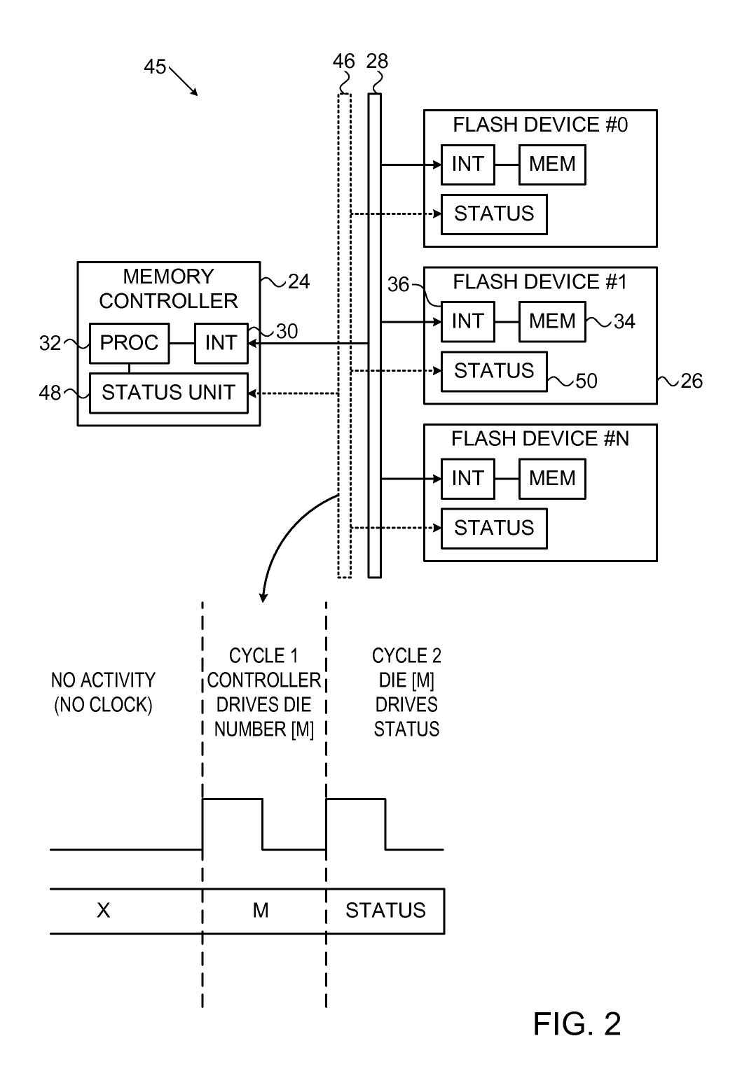

FIG. 2 is a block diagram that schematically illustrates a memory system 45, in accordance with an alternative embodiment of the present invention. In this configuration, memory controller 24 and memory devices 26 are connected by a parallel status bus 46. Status bus 46 is separate from I/O bus 28 that is used for data storage. Thus, memory controller 24 communicates with memory devices 26 using two separate and independent buses—I/O bus 28 for data storage, and status bus 46 for status querying and reporting.

In this configuration, memory controller 24 comprises a status unit 48, and each memory device comprises a respective status unit 50, for querying and reporting the status of memory devices 26 over status bus 46. (Status unit 50 is also referred to as a R/B unit, and may be used for reporting various types of status of any desired complexity.)

In an example embodiment, each memory device 26 is assigned by memory controller 24 a unique address for the purpose of status querying and reporting. The memory controller queries the status of a given memory device in a two-cycle process, as can be seen at the bottom-left of FIG. 2. The address of the given memory device is denoted M. In a first cycle of bus 46, status unit 48 in memory controller 24 sends a status request over status bus 46. The status request indicates the address M of the given memory device. In the next cycle of status bus 46, the queried memory device responds by sending its status report on status bus 46.

In the present example, the status request and the status report occur in two successive cycles of bus 46. In alternative embodiments, the status request and status report may occur in non-successive bus cycles, for example in order to allow the queried memory device more time to provide its status report.

In the embodiment of FIG. 2, the memory device sends its status report in a single cycle of status bus 46. In alternative embodiments, the memory device may send its status report in two or more cycles of the status bus, following the status request. This feature enables the memory device to report richer, higher-complexity or higher-granularity status.

In this embodiment, for N+1 memory devices, the number of lines in status bus 46 is Log₂(N+1), so as to enable a sufficient number of bits for assigning unique addresses to the N+1 memory devices, plus a clock signal.

For example, when system 45 comprises thirty-two Flash dies connected to a single I/O bus 28, status bus 46 (and thus each die) should comprise six lines—five I/O lines denoted PRNB_{IO}[4:0] and a clock line denoted PRNB_{CLK}.

In order to obtain the R/B status of die [M], memory controller 24 toggles the PRNB_{CLK} clock signal twice. In the first cycle all PRNB_{IO}[4:0] lines of bus 46 in the die are defined as inputs, and the memory controller puts the address M on the bus. In the second cycle, die [M] puts its R/B status on the PRNB_{IO}[4:0] lines, and the memory controller configures its PRNB_{IO}[4:0] lines to become inputs and reads the PRNB_{IO}[4:0] lines to obtain the R/B status. The response may comprise up to Log₂(N) bits.

The system configurations of FIGS. 1 and 2 are able to achieve small storage latency and high I/O bus utilization because of the separation between the status bus from the I/O bus used for data storage. For example, when a current storage transaction is in progress on the I/O bus, the memory controller may query the status of the memory devices using the separate status bus, such that the up-to-date status is already available when the current storage transaction ends.

Thus, the memory controller is able to configure the next storage transaction based on the up-to-date memory device status, and start the next storage transaction immediately after the end of the current transaction. For example, the memory controller may find out which memory devices are busy and which are ready during the current transaction, and address the next transaction to the ready memory devices. Thus, the memory controller is able to start the next transaction immediately when the current transaction is completed, without a need to allocate time for status querying and reporting between the transactions.

In the system configurations of FIGS. 1 and 2, memory controller 24 may be implemented in hardware. Alternatively, the memory controller may comprise a microprocessor that runs suitable software, or a combination of hardware and software elements. In some embodiments, processor 32 of memory controller 24 comprises a general-purpose processor, which is programmed in software to carry out the functions described herein. The software may be downloaded to the processor in electronic form, over a network, for example, or it may, alternatively or additionally, be provided and/or stored on tangible media, such as magnetic, optical, or electronic memory.

The system configurations of FIGS. 1 and 2 are example configurations, which are shown purely for the sake of conceptual clarity. Any other suitable memory system configuration can also be used. For example, system 20 may comprise any suitable number of memory devices of any desired type. Elements that are not necessary for understanding the principles of the present invention, such as various interfaces, addressing circuits, timing and sequencing circuits and debugging circuits, have been omitted from the figure for clarity.

In the exemplary system configurations shown in FIGS. 1 and 2, Flash devices 26 and memory controller 24 are implemented as separate ICs. In alternative embodiments, however, the Flash devices and the memory controller may be integrated on separate semiconductor dies in a single Multi-Chip Package (MCP) or System on Chip (SoC), and may be interconnected by an internal bus. Further alternatively, some or all of the memory controller circuitry may reside on the same die on which one or more of the Flash devices are disposed. Further alternatively, some or all of the functionality of memory controller 24 can be implemented in software and carried out by a host. In some embodiments, the host and memory controller may be fabricated on the same die, or on separate dies in the same device package.

Although the embodiments described herein mainly address status polling in memory devices, the methods and systems described herein can also be used in other applications, such as in various other types of Integrated Circuits (ICs).

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Apparatus, comprising:
multiple memory devices; and
a memory controller, which is configured to store data by communicating with the memory devices over a first bus interface, and to query a status of the memory devices by communicating with the memory devices over a second bus interface that is separate from the first bus interface.

2. The apparatus according to claim 1, wherein the memory devices and the memory controller are connected in a serial cascade using the second bus interface, wherein each memory device is configured to receive a partial status word from a preceding element in the cascade, to add a respective status report of the memory device to the partial status word and to send the partial status word having the added status report to a next element in the cascade.

3. The apparatus according to claim 2, wherein the memory controller is configured to receive a full status word from a last memory device in the cascade, and to extract respective status reports of the multiple memory devices from the full status word.

4. The apparatus according to claim 1, wherein the memory controller is configured to send to each memory device over the second bus interface a respective status request indicating a respective address of the memory device, and wherein each memory device is configured to respond to the status request by sending a respective status report over the second bus interface.

5. The apparatus according to claim 4, wherein the memory controller is configured to send the status request in a first cycle of the second bus interface, and to receive the respective status report in one or more second cycles of the second bus interface that are subsequent to the first cycle.

6. The apparatus according to claim 1, wherein the second bus interface is serial.

7. The apparatus according to claim 1, wherein the second bus interface is parallel.

8. The apparatus according to claim 1, wherein the memory controller is configured to query the status of the memory devices using the second bus interface concurrently with conducting a current storage transaction in the memory devices using the first bus interface.

9. The apparatus according to claim 8, wherein the memory controller is configured to specify a subsequent storage transaction based on the queried status.

10. The apparatus according to claim 8, wherein the memory controller is configured to initiate a subsequent storage transaction based on the queried status immediately following an end of the current storage transaction.

11. The apparatus according to claim 1, wherein the status comprises, for each memory device, a respective indication that indicates whether the memory device is busy or ready to receive a subsequent command on the first bus interface.

12. A method, comprising:
using a memory controller, storing data in multiple memory devices by communicating with the memory devices over a first bus interface; and
querying a status of the memory devices using the memory controller by communicating with the memory devices over a second bus interface that is separate from the first bus interface.

13. The method according to claim 12, wherein the memory devices and the memory controller are connected in a serial cascade using the second bus interface, and wherein querying the status comprises receiving in each memory device a partial status word from a preceding element in the cascade, adding a respective status report of the memory device to the partial status word and sending the partial status word having the added status report to a next element in the cascade.

14. The method according to claim 13, wherein querying the status comprises receiving in the memory controller a full status word from a last memory device in the cascade, and extracting respective status reports of the multiple memory devices from the full status word.

15. The method according to claim 12, wherein querying the status comprises sending from the memory controller to each memory device over the second bus interface a respective status request indicating a respective address of the memory device, and responding to the status request by each memory device by sending a respective status report over the second bus interface.

16. The method according to claim 15, wherein querying the status comprises sending the status request in a first cycle of the second bus interface, and receiving the respective status report in one or more second cycles of the second bus interface that are subsequent to the first cycle.

17. The method according to claim 12, wherein the second bus interface is serial.

18. The method according to claim 12, wherein the second bus interface is parallel.

19. The method according to claim 12, wherein storing the data comprises conducting a current storage transaction in the memory devices using the first bus interface, and wherein querying the status is performed concurrently with conducting the current storage transaction.

20. The method according to claim 19, wherein storing the data comprises specifying a subsequent storage transaction based on the queried status.

21. The method according to claim 19, wherein storing the data comprises initiating a subsequent storage transaction based on the queried status immediately following an end of the current storage transaction.

22. The method according to claim 12, wherein the status comprises, for each memory device, a respective indication that indicates whether the memory device is busy or ready to receive a subsequent command on the first bus interface.

23. Apparatus, comprising:
an interface for communicating with multiple memory devices; and
circuitry, which is configured to store data in the memory devices by communicating with the memory devices over a first bus, and to query a status of the memory devices by communicating with the memory devices over a second bus that is separate from the first bus.

24. Apparatus, comprising:
a memory; and
circuitry, which is configured to exchange data between the memory and a memory controller by communicating with the memory controller over a first bus, and to provide a status of the apparatus by communicating with the memory controller over a second bus that is separate from the first bus.
